(19) United States
(12) Patent Application Publication
(10) Pub. No.: US 2008/0133222 A1
(43) Pub. Date: Jun. 5, 2008

(54) SPELL CHECKER FOR INPUT OF REDUCED KEYPAD DEVICES

(76) Inventors: Yehuda Kogan, Tel Aviv (IL); Ofer Digly, Tel-Aviv (IL); Moshe Sivan, Ra'anana (IL); Shay Harari, Holon (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/946,443

(22) Filed: Nov. 28, 2007

Related U.S. Application Data
(60) Provisional application No. 60/861,715, filed on Nov. 30, 2006.

(51) Int. Cl. G06F 17/27

(52) U.S. Cl. 704/9

(57) ABSTRACT

The present invention discloses a system and a method for spell checking of an input text inserted by a user through a multiple-typing reduced numeric keypad device. The correction may be based on comparison to at least one given reference database vocabulary containing words and associated representation sequences, where the representation sequences may be: (i) Numeric Representations (NR) and Key Presses (KP) sequences. The NR is a sequence representing the digits numbers required to achieve a given word where the KP represents the sequence of the number of key presses required to reach each character in a key. For example sequences of the word “big” using a standard mobile phone reduced keypad: NR=244 and KP=231.

### CROSS-REFERENCE TO RELATED APPLICATIONS

This application claims the benefit under 35 U.S.C. §119(e) of U.S. Provisional Patent Application No. 60/861,715 filed on Nov. 30, 2006, the content of which is incorporated by reference herein.

### FIELD OF THE INVENTION

The present invention relates generally to the field of software tools for keypad-related devices. More specifically, the present invention is a method for searching for and correcting input text inserted via a reduced numeric keypad device.

### BACKGROUND OF THE INVENTION

Writing and sending text massages using communication devices became extremely popular in recent years. Such text message communication is often referred to as Short Message Service or SMS. Mobile phones and similar devices that use reduced numeric keypads are increasingly updated to fit various types of communication forms, such as enabling access to internet services for browsing websites, receiving emails, etc.

Unlike the standard typewriter layout where each key typically represents a single letter or a number, reduced numeric keypads reduce the number of keys used to represent a set of characters so that each key-number may represent more than one character. For example, a typical telephone reduced numeric keypad wherein each number key may also represent several additional letters or symbols: e.g. a key labeled “2” may represent the following characters: “a”, “b”, “c” and “2” etc.

Using a reduced numeric keypad for inserting text massages may produce a great potential for typing and spelling mistakes, since inserting of text via such a keypad requires an unintuitive inserting of an input of characters via a keypad that is indicated by numbers.

Most methods for checking and correcting of input text inserted via a reduced numeric keypad of a communication device, such as disclosed in patent applications numbers: U.S. Pat. No. 6,011,554 by King Martin T. and Grover Dale L.; US2002188448 by Goodman Joshua T. and Venolia Gina D.; and US2003011574 by Goodman Joshua T., use a typing technique by which the user presses keys that hold the input characters in their reduced form. Each character that composes a desired input word relates to a single-tapping over a key that reduces the said desired character. For example: A reduced numeric keypad in which the numeric key labeled “2”—reduces the characters: “a”, “b”, “c” and “2”, and a reduced numeric keypad in which the numeric key labeled “4”—reduces the characters: “g”, “h”, “i” and “4”. In order to insert the word “big” as an input text, a user will be required to press the keys two, four and four accordingly—a single press on each key. Since the keys two, four and four represent more characters than the ones compositing the word “big”, only a database dictionary can output a word out of all character string combinations of the keys sequence: 244.

Although this technique reduced the number of key-presses required to achieve an input word, the far more practiced and common one is a technique that uses the cyclic order of the characters that are reduced to each key to achieve every character compositing the input word: e.g. the cyclic order of the key labeled “2” is “a”, “b”, “c” and “2”. Therefore—to insert the input character “b” the user has to press two key presses over key-labeled “2”. This technique is known as “multiple-tap”.

Although eliminating of said use of multiple tapping over the keys to produce each character enables a quick entering of input text the elimination of the multiple-presses option over the reduced numeric keypad, deprives farther knowledge of the user's intentional input that may have been used for the checking of the input text through a database vocabulary and the correcting methods.

Said methods that eliminates the use of multiple tapping, create two main difficulties: (1) the user cannot see the characters that he intended to type until the full word is accomplished, and only if the user had typed the correct keys to obtain the desired word. For example, to type the first letter “b” of the word “big” the user has to press key number “2”, which also represents the characters: “a”, “c” and “2”. In this case the user will not see the letter “b” appear on the device screen unless the numeric sequence of the entire word is established. (2) The output of the said methods is a list of words corresponding to said numeric representation. The said output list is then sorted only according to a statistical algorithm, and cannot “guess” the user desired input text otherwise.

Another problem that occurs when using such methods, is when the user makes a spelling mistake and accidentally presses a different key then the one that is numerically required to compose the desired word, said methods will not be able to find matches within database vocabulary, and will not be able to output a correction.

Creating a text massage composed of more than one language via a reduced numeric keypad can be quite annoying, since the user is usually required to exit one language through a menu application and re-enter another language. This may be both time and nerve—consuming.

### SUMMARY OF THE INVENTION

The present invention discloses a system and a method for spell checking of an input text inserted by a user through a multiple-typing reduced numeric keypad device. The correction may be based on comparison to at least one given reference database vocabulary containing words and associated representation sequences.

According to some embodiments of the invention the system may comprise a reduced numeric keypad comprising reduced keys where each key may represent more than one character, as known in the art, a processing unit enabling to process data and a display unit enabling to display text. The system may enable translating the input text to representation sequences: (i) Numeric Representation (NR) corresponding to the representing numbers of the typed keys of the keypad and (ii) Key Presses (KP) which is a sequence of numbers representing the number of key presses required to achieve each character of the input text, wherein said translation relates to the typing method and keypad design. For example, in a reduced key, the digit “2” may represent four different characters: ‘a’, ‘b’, ‘c’ and ‘2’: to reach the character ‘c’ the user may be required to press three time upon the key digit “2”. Accordingly, to input the word “big” the numeric representation (NR) sequence may be the digits: “244” where the KP sequence may be “231”.

According to some embodiments of the invention, the system may enable searching through a database associated and/or integrated with the system for words that have NR sequences that are equivalent to the input text NR sequence; calculating the typing distance (TD) between the text corresponding with the equivalent NR sequences found in the database and the KP sequence of the input text; and sorting the text of equivalent NR sequences according to the TD values. According to some embodiments of the invention, the sorting of the output text may be carried out according to ascending TD values of the equivalents.

According to some embodiments of the invention, additionally to the module that checks the spelling according to NR equivalents and TD values, the system may integrate additional modules for checking and correcting of said input text. The additional modules may be, for example, a phonetic model as known in the art, enabling to find and correct the misspelled word with the corrected one even when the NR sequence of the collected word is different than the one of the input word. An additional module integrated in the system may be, for example, a cyclic module enabling to calculate the cyclic equivalents of the input text NR and KP (CNR and CKP); and search the database for text with NR and KP sequences that arc equivalent to the input text CNR and CK (shall be further elaborated in the next chapters).

According to embodiments of the invention, the invention, each module may contribute corrected word(s) according to the module's algorithm and method. To sort the list of corrections resulting from the modules an advanced TD value may be calculated reflecting the typing distance between the corrected word and the input word. The list may be sorted according to ascending advanced typing distance (ATD) values. The ATD values may be calculated according to predefined weight values, where the typing distance between each character of the input text and the corresponding character of the character of the list-text may be calculated according to a given weight value ascribed to said distance.

The weight values between characters may be updated by the system according to statistical learning processes embedded in the method and the modules.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1, is an illustration of a reduced numeric keypad and an example of commonly used typing definitions for multiple-tap numeric keypads, according to some embodiments of the present invention.

FIG. 2 is a flowchart that illustrates a numeric module for spell checking and correction, including a first typing distance (TD) output sorter according to some embodiments of the present invention.

FIG. 3 is an illustrative example of the numeric module and TD sorting process, according to some embodiments of the present invention.

FIG. 4 is an illustration of an advanced spell corrector comprised of an advanced TD sorting method, according to some embodiments of the present invention.

FIG. 5 is an illustration of a cyclic module flowchart, according to some embodiments of the present invention.

FIG. 6 is an exemplary illustration of the cyclic module, according to some embodiments of the present invention.

FIG. 7 is an illustration of a phonetic module, according to some embodiments of the present invention.

FIG. 8 is a graphic illustration of an advanced typing distance (ATD) matrix, according to some embodiments of the present invention.

FIG. 9 is an exemplary illustration of an advanced spell corrector, according to some embodiments of the present invention.

The drawings together with the description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF SOME EMBODIMENTS OF THE INVENTION

The present invention discloses a novel system and a method for checking and correcting typing and spelling of input text retrieved from a reduced numeric keypad, which is an alphanumeric keypad that reduces several characters into each key such as commonly used in mobile phones and TV remote controls keypads, for example.

The term “reduced numeric keypad” shall he referred to hereinafter as a numeric keypad.

The present method of correcting and checking input text inserted via a numeric keypad device, wherein the checking and correction is based on comparison to at least one given reference database vocabulary wherein the said comparison to a database vocabulary shall be referred to hereinafter as “parsing process” or “parsing”.

The present method relates to input text inserted by a user that may be human or a machine via said numeric keypad. Input text inserted via said numeric keypad may be transmitted to any electronic receiving device and any device that enables representation and parsing process of input text.

It is noted that, although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. For example, the methods that have been described can be stored as computer programs oil machine-or computer-readable media, and executed there-from by a processor.

It is to be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” refers to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specifications are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Unless specifically stated otherwise, as apparent from the following discussions, it is to be understood that utilizing terms such as “computing”, “processing”, “determining”, “calculating,” or the like, refer to the action or processes or both of a computer or computing system, or similar electronic computing device, that manipulate and/or transform data represented as physical such as electronic quantities within the computing system's registers and/or memories into other data similarly represented as physical quantities within the computing system's memories, registers or other such transmission, information storage or display devices.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

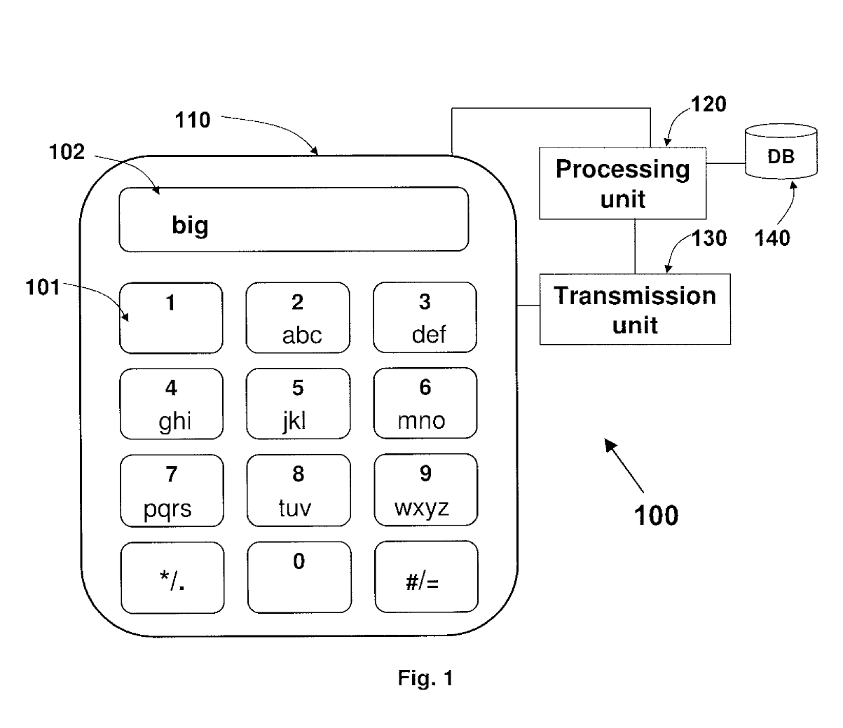

FIG. 1 schematically illustrates a system 100 for checking and correcting of text, according to some embodiments of the invention. The system 100 may comprise:
a reduced numeric keypad 110 comprising reduced keys 101 and at least one displaying unit 102, where each key 101 represent a set of one or more characters. For example, a key 101 imprinted with the number “2”, may represent a character set comprising “a”, “b”, “c” and “2”, in that order, where the order of the character set represents the number of taps or presses of the key 101 required to achieve a desired character. In many cases, as an example, a pause between key-presses for a certain time period signals a transition to the entering of a new character.
at least one database 140 that may contain words' numeric values and other indicators identifying the spelling of the words;
a processing unit 120 enabling to retrieve data from the database 140 and perform parsing of the input data and the spell checking, according to predefined algorithms; and
a transmission unit 130 enabling to transmit and retrieve data, where the transmission unit 130 may enable transmitting the input text to a remote processing unit 120 and/or the from a processing unit 120 embedded in the keypad 110 to a remote terminal.

According to some embodiments of the invention the system 100 may be a communication device enabling wireless or non-wireless communication such as, for example, a personal computer (PC) with an internet connection, a cellular phone, a laptop with wireless network connection and the like.

According to some embodiments of the invention, the database 140 vocabulary may be translated to numeric representation (NR) and key presses (KP) sequences representing the sequence of characters comprising the text, corresponding to reduced keys label-numbers and the number of presses over keys required to obtain a certain word within the said vocabulary and an input text. As an example, the word ‘big’ may be represented as follows:

| Letter | NR | KP | | |
|---|---|---|---|---|
| b | 2 | 2 | [symbol] | Two Key Presses on key labeled ‘2’ |
| i | 4 | 3 | [symbol] | Three Key Presses on key labeled ‘4’ |
| g | 4 | 1 | [symbol] | One Key Press on key labeled ‘4’ |

Representing sequences of the word ‘big’: NR=244 KP=231

A parser algorithm in the processing unit 120 may translate the word ‘big’ inserted by the user according to the above example of representing sequences. According to the above example, words from the database vocabulary 140 may be associated with their corresponding NR and KP sequences in the same way as the translation of input text into representing sequences.

The present method and its parsing processing may enable comparison of NR and KP sequences of input text to sequences in the database 140 vocabulary.

Numeric keypad text input may be generated and transmitted by one of two approaches, relating to the way in which input text is typed by the user, via tapping or pressing of numeric keypad keys. Said approaches are a multiple-tap approach and a single-tap approach.

In a multiple-tap approach, input text is represented as a string of characters whereas each character corresponds to at least one key press typed by a user, to compose the desired text. If the text is composed from two sequential letters that are represented by the same reduced numeric key, the user may be obliged to pause between inputting characters. If, for example, the user must press numeric keys that also represent alphabetic characters, then in order to type the character string as represented in FIG. 1 by the word ‘big’, the user may be required to press the following sequence: two presses on the key labeled “2” for ‘b’ 22, three presses on the key labeled “4” for ‘i’ 44, pause, one press on the key labeled “4” for ‘g’ 44. The multiple-tap approach enables modulation in which the input string of characters may be translated into key presses (KP) and numeric representation (NR) sequences.

In a single-tap approach, text is input as a string of characters, where each character corresponds to a single key press typed by the user. According to this approach, every press on a reduced numeric key represents all characters that are reduced into this single key. For example, in order to type the word ‘big’ 102, the user will type the following sequence: one press on the key labeled “2” 22, one press on the key labeled “4” 44, one press on the key labeled “4” 44. According to this approach, input text can only be translated to a Numeric Representation (NR) sequence.

The term:“multiple-tap approach” shall be referred to hereinafter as m-tap, and the term“single-tap approach” shall be referred to hereinafter as s-tap.

The present invention enables receiving, transforming and processing of both m-tap and s-tap numeric keypad input, according to some embodiments of the invention.

According to some embodiments of the invention parsing process may include comparing input text to database vocabulary by searching matching NR and KP sequences. Matching NR and KP sequences in database vocabulary output a list of optional corrections to input text.

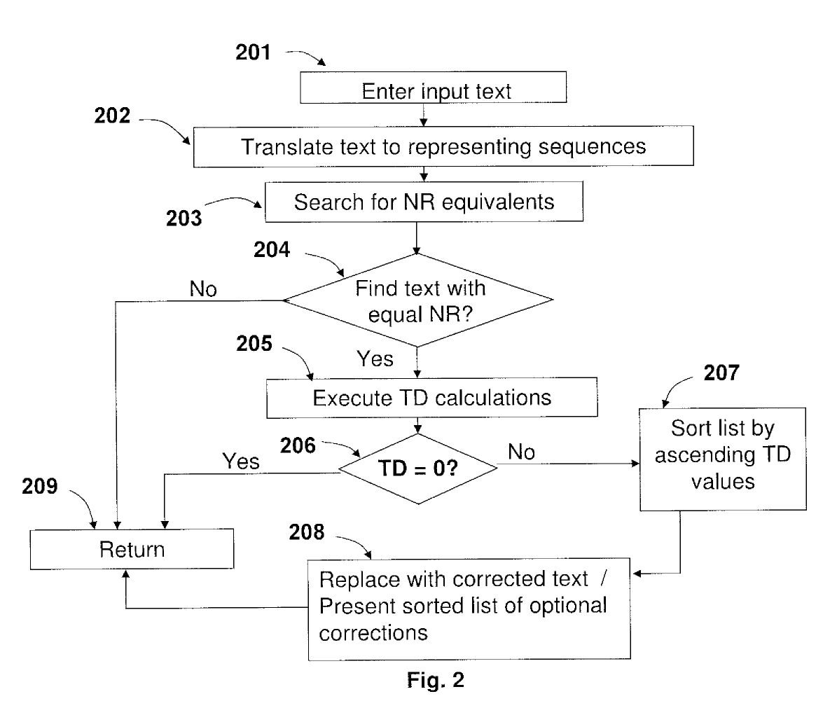

FIG. 2 schematically illustrates a process for spelling check and correction of input text, according to some embodiments of the invention. The process may comprise the steps of:
inputting text 201, where the user may input the text using an m-tap numeric keypad 110;
a translating the input text into NR and KP representing sequences 202;
searching for NR equivalents 203, where the processing unit 120 enables searching through the database 140 for the equivalents;
If no such equivalents are found 204—parser returns 209 with no optional corrections and may leave input text uncorrected;
If such equivalents are found 204,the parser may execute Typing Distance (TD) calculations 205, for example, according to the following modulation:
The parse executes the following equation for each separate equivalent word found in the database vocabulary 206:

(Typing Distance)TD=Σ_{each letter}|KP_{DB}−KP_{Rof}|

### Wherein:

KP_{DB} represents the key presses required to achieve each character in a word from the said database
KP_{ref} represents the key presses required to achieve each character in the word from the referenced input word.
The parser may search the database 140 for words that have TD value that equals zero 206;
If such word is found, (for which TD=zero) the parser may return 209 with no optional corrections (the input text spelling is correct);
If the parser cannot find a database KP equivalent for which TD equals zero—parser sorts all NR equivalent words found in database vocabulary (herein defined as: optional corrections) in a TD ascending order 207, where the first word on the list may be, for example, the one with the smallest TD value and so forth.
Presenting the list of NR equivalents 208 according to ascending TD values.

Alternatively, upon calculating the TD values of all the NR equivalents, the list of equivalents in a TD ascending value order may automatically be presented including the TD=0 value.

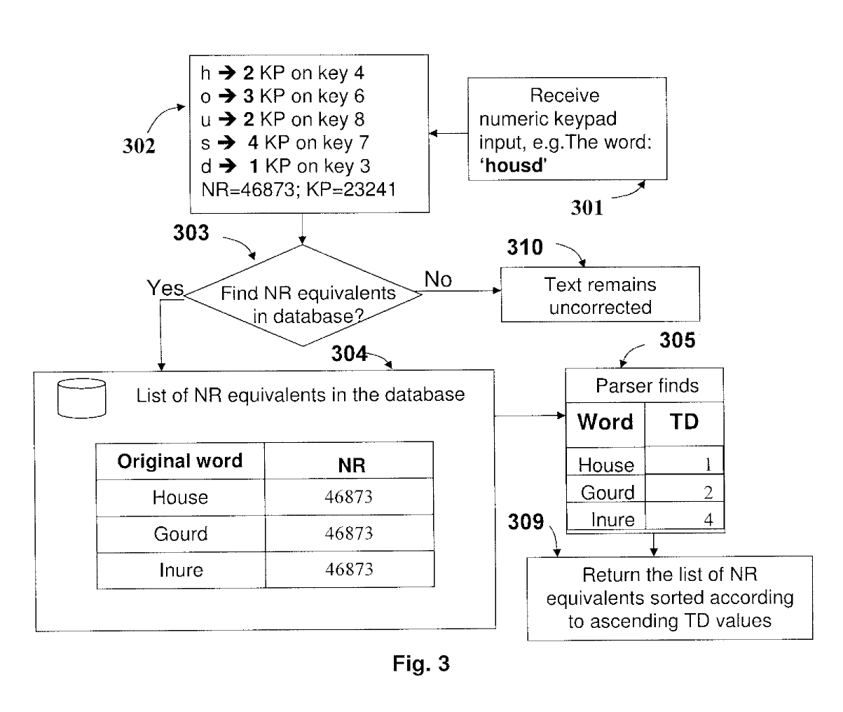

FIG. 3 schematically illustrates a specific example of the module described in FIG. 2, according to some embodiments of the invention.

As an example, indicated in box 301, the user may type the text “housd” in an m-tap numeric keypad 302. The module may execute a translation of the keypad typing into NR and KP sequences (NR=46873; KP=23241). The module may then search the database 140 for text with an identical NR sequence to find NR equivalents 303-304. The TD of each NR equivalent that had been found by the parser may be checked 305. A list (if words with equivalent NR sequences and various TD values may be presented to the user sorted according to ascending TD values 309.

According to some embodiments of the invention, the TD values may be calculated according to the calculation specified in FIG. 2, which may be explained as follows:

Reference text: ‘housd’ equals TD (house)=0+0+0+0+1=1

TD (gourd)=1+0+0+1+1=2

TD (inure)=1+1+0+1+1=4

According to some embodiments of the invention, spell corrections and output results may be adjusted to external software applications and databases 140 e.g. a spell-checker for ordering from restaurant on-line menus via mobile phones Short Message Service (SMS), for which the database vocabulary, may be limited to a restaurant menu vocabulary. According to this example, output corrections may be automatically sent to and received by one or more software applications as well as a text box exhibiting optional corrections to the user.

According to some embodiments of the invention, the method for spell correction may be composed of several spell correction-modules integrated to a single process. Every module may contribute additional words, text-forms, or both to a list of optional correction from which a user or any other receiver of the said corrections (e.g. a machine) may choose.

According to some embodiments of the invention, the parsing method may be divided into two defined categories as two possible embodiments of the invention: a spelling corrector module, which may be applied to input text received from m-tap numeric keypads, and an advanced spelling corrector module, which may be applied on input from s-tap numeric keypads, m-tap numeric keypads, or both.

According to some embodiments of the invention, the first module of a spelling corrector may be defined as the embodiments illustrated in FIG. 2 and FIG. 3, wherein the parser of the first module execute TD calculations for the sorting of the said list of optional corrections.

According to some embodiments of the invention, the advanced spelling corrector (ASC) module may be composed of several sub-modules all related to an advanced typing distance (ATD) calculation method: In the ASC module each sub-module contributes a list of optional corrections to a main list, according to each sub-module comparison technique with a database vocabulary. All optional corrections extracted from all said sub-modules may then be processed through an ATD method, which is a statistical algorithm that calculates the distances between an input text and an optional correction word according to a statistical cost value. ATD value may then be calculated to each optional correction word and the advanced parser may then sort the said list by ascending ATD values.

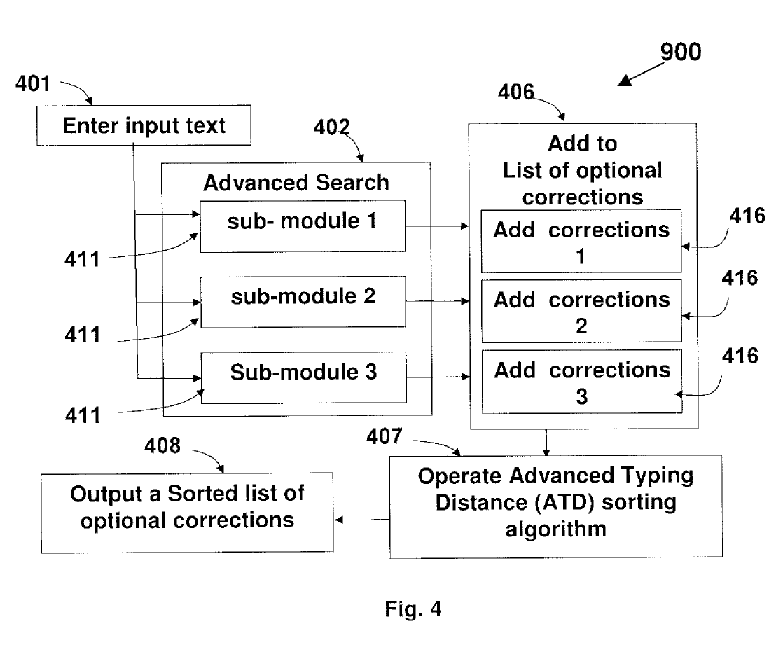

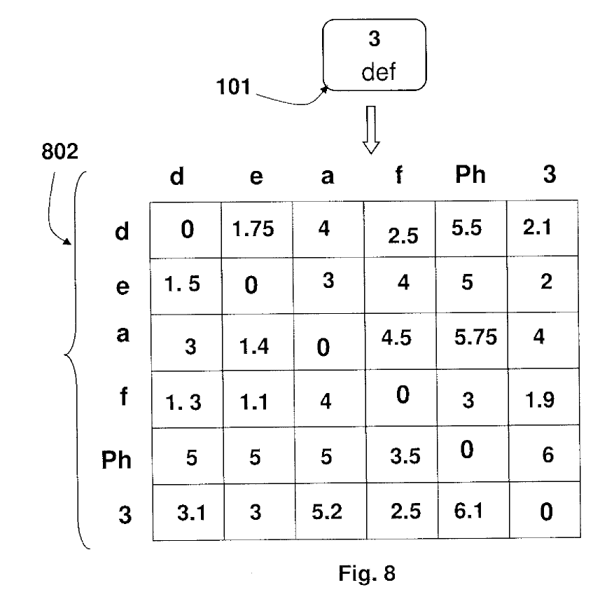

FIG. 4 schematically illustrates an exemplary advanced spelling corrector (ASC) 900 configuration, according to some embodiments of the invention. The ASC 900 may be operated through the following process:
The user inputs text via a numeric keypad, 401.
The advanced search parser 402 operates several sub-modules 411. Each sub-module output corrections for the given input, according to its own parsing and algorithm modulations 403, 404 and 405.
Corrections 416 may then be added to a list of optional corrections, containing all sub-module findings 406.
The list of optional corrections may then be processed and sorted by an advanced typing distance (ATD) algorithm 407 (exemplified in following FIG. 8).
the sorted list of corrections may be output to a receiving device 408 such as, for example, a screen, a text box, or any other receiving device or software.

According to some embodiments of the invention, the said sub-modules may include the module described in FIG. 2, which shall be referred to hereinafter as the ‘numeric sub-module’, a cyclic sub-module, which is a module that relates to the characters cyclic order in which m-tap numeric keys correspond to, and other existing methods for spell correcting.

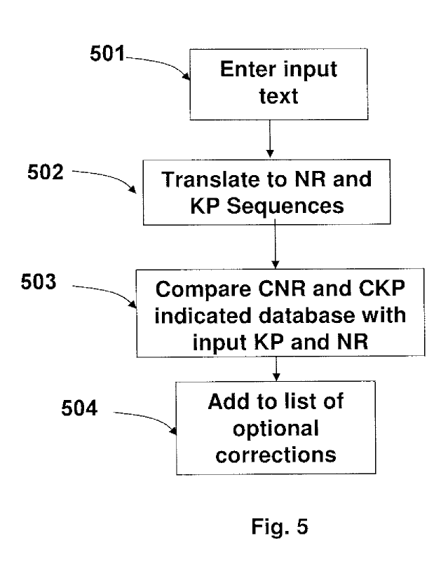

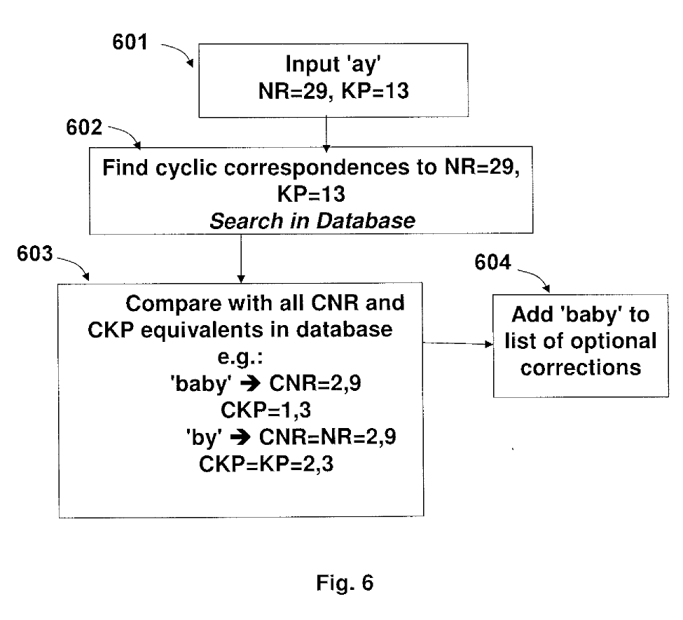

FIG. 5 schematically illustrates a cyclic sub-module, according to some embodiments of the invention. As an example, indicated in box 501, the user may input text using an m-tap reduced numeric keypad. The cyclic module translates input text into NR and KP sequences 502. The cyclic sub-module compares the input KP and NR sequences with the cyclic numeric representation CNR and cyclic key presses CKP sequences of the database vocabulary 503, wherein translation method of database vocabulary into CNR and CKP sequences is illustrated at the next paragraph of FIG. 6. All database vocabulary words found with both CNR and CKP matches to the input NR and KP sequences in accordance may be added to an output list of corrections 504.

FIG. 6 schematically illustrates an example of a cyclic sub-module, adjusted to receive an input text from an m-tap numeric keypad 110, according to some embodiments of the invention. The parser sub-module receives input text via a numeric keypad 110 that produces the character combination ‘ay’ 601, which is translated to an NR sequence equal to 29 and KP sequence equal to 13. The cyclic module of this example resolves misspells resulting from skipped pauses in key pressings, using reduced numeric key cycles. The word ‘baby’, for instance, requires: two KPs on key 2 plus a pause plus one KP on key 2 plus a pause plus two KPs on key 2 plus three KPs on key 9.

The resulting NR is 2229 and the resulting KP sequences are 2, 1, 2, and 3. The following example illustrates a possible situation in which the user fails to pause between key presses of the same key as required to achieve sequence characters that are represented by the same reduced numeric key. The user has pressed numeric key labeled 2 22 five times, that is two KPs plus one KP plus two KPs, without a pause in between each group of KPs. This will produce the string ‘ay’, which corresponds to an NR equaling 29 and KP sequences of 13.

The cyclic sub-module may then search for cyclic correspondences to the input KP and NR, as indicated by the examples in boxes 602-603, wherein: d₂ is an example of a cyclic constant for numeric key 2. Key 2 represents four characters: “a”, “h”, “c”, and “2”. Accordingly, d₉ is an example of a cyclic constant for numeric key 9. Key 9 represents five characters “w”, “x”, “y”, “z”, and “9”. Hence,

d₂=4.

d₉=5
K and J are arbitrary integers.
The word ‘baby’ is a legitimate word from database and its cyclic representations, according to the example, are CNR is the cyclic numeric representation and CKP is the number of cyclic key presses:

| Letter | NR | KP | CNR | CKP |
|---|---|---|---|---|
| b | 2 | 2 | 2 | =KP(SUM) − d₂ |
| a | 2 | 1 | | ↓ |
| b | 2 | 2 | | 5 − 4 = 1 |
| y | 9 | 3 | 9 | KP(SUM) = 3 |

As an example to these cyclic sub-module calculations, the following terms are taken into consideration:
i. CNR and CKP are calculated and added to each set of sequential letters in the database text, which are represented by the same numeric key. As in the above example, the first three sequential characters of the word ‘baby’, “b”-“a”-“b”, are represented with the said numeric key labeled 2.
ii. In calculating the CKP sequence, the cyclic constant d is subtracted only it the following algorithm applies:

KP(SUM)>d

For example, as indicated in box 603, the legitimate word ‘by’ in a database vocabulary has the same CNR sequence as the input NR but the CKP sequence is not equal to the input KP sequence, and hence, the word ‘by’ will not be added to list of optional corrections by the cyclic sub-module. As an example, as indicated in box 604, the cyclic nodule contributes the word ‘baby’ to the list of optional corrections.

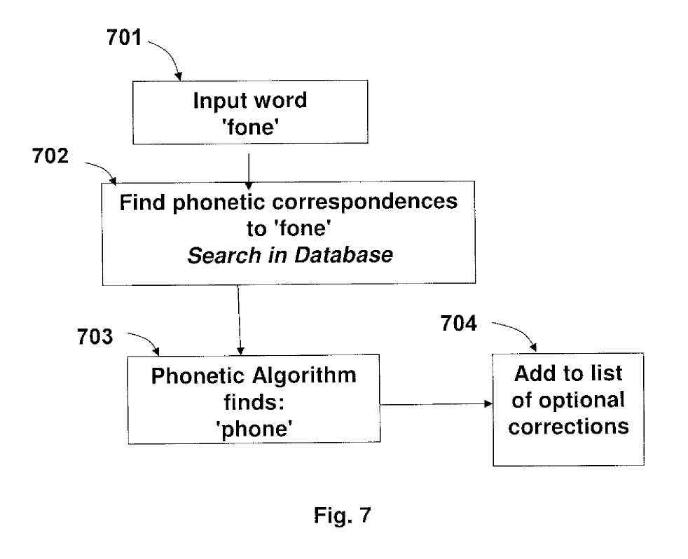

FIG. 7 schematically illustrates a phonetic sub-module that may be further added to the advanced spell correction modules. As an example, as indicated in box 701, the user inputs the word ‘fone’. The phonetic module recognizes the coupled characters ‘ph’ as a possible phonetic replacement to the character ‘f’, and finds a legitimate word in the database that corresponds to replacing ‘f’ with ‘ph’, as indicated, for example, in boxes 702 and 703. The word ‘phone’ may then be added to, for example, the list of corrections, as indicated in box 704.

FIG. 8 schematically illustrates an exemplary advanced TD (ATD) matrix or table of numeric values assigned to a numeric key, as indicated in the example in box 801. In this example, the numeric key 3 represents four characters: “d”, “e”, “f”, and “3”. The ATD value matrix given as an example in box 802 represents an exemplary value or weight ascribed to each corresponding character embedded in the numeric key, and characters or character-combinations that correspond to phonetically or otherwise embedded key characters.

According to the example, illustrated in FIG. 8, the character ‘e’ may phonetically correspond to the character ‘a’, and the character ‘f’ may phonetically correspond to the character-combination ‘ph’, hence these two options are added to the matrix of numeric key 3.

The numbers given in the matrix 802 in FIG. 8 is arbitrary and may be calculated or implemented according to statistical evaluations and according to, for example, the frequencies by which users misspell or mistype input text. ATD matrix weight values may also be updated and adjusted according to statistical learning processes, through which ATD matrices may constantly change both in value and in matrix-size. As an example, more phonetic correspondents may be added to a matrix of a key and hence the number of rows and columns may increase and the TD value may change according to user statistics.

For example, as indicated in box 802, the column indication represents user input characters, and the row indication represents optional replacements:

Optional
correspondents

| Input typing | d | e | a | f | ph | 3 |
|---|---|---|---|---|---|---|
| d | 0 | 1.75 | 4 | 2.5 | 5.5 | 2.1 |
| e | 1.5 | 0 | 3 | 4 | 5 | 2 |
| a | 3 | 1.4 | 0 | 4.5 | 5.75 | 4 |
| f | 1.3 | 1.1 | 4 | 0 | 3 | 1.9 |
| ph | 5 | 5 | 5 | 3.5 | 0 | 6 |
| 3 | 3.1 | 3 | 5.2 | 2.5 | 6.1 | 0 |

For the purpose of further illustration, the cost value for a probability that the user will type ‘f’ and that the correction may be ‘ph’, which in this arbitrary example has the cost value of 3, may be larger than the cost value for a probability that the user will type ‘ph’ and the correction will be ‘f’, which in this arbitrary example has the cost value of 3.5. In that manners the cost value decreases according to increasing probabilities.

In another example, the probability of a user confusing ‘f’ with ‘ph’ may be larger than the probability for confusing ‘e’ with ‘k’. In that case the matrix cost values for input for ‘f’ instead of ‘ph’ will be smaller than the cost value for input ‘c’ instead of ‘k’.

The diagonal of the matrix may be zeroed, representing the highest probability for the input to be the same as the correction. According to some embodiments of the invention, the ATD values may be calculated as follows:

(Advanced Typ ng Distance)ATD=ΣᵢⱼMVᵢⱼ

### Whereas MVᵢⱼ is the matrix component, relating the TD between characters or character combinations in the input word to the characters or character combinations in the corrected word.

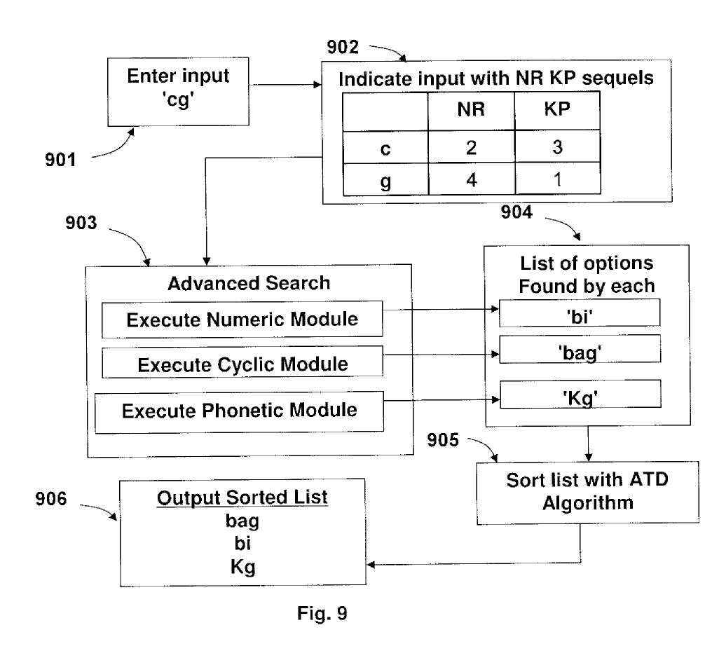

Reference is now made to FIG. 9, which schematically illustrates an exemplary configuration and illustration of an advanced spell corrector (ASC), according to some embodiments of the invention. As indicated by the example in box 901, the user enters the string ‘cg’, using an in-tap numeric keypad 110. The module executes translation of the input text to NR and KP sequences, as indicated in box 902 where the NR sequence is 24 and the KP sequence is 31.

As indicated by the example in box 903, the advanced search is executed and operates the modules to forth a list of optional corrections. The order in which the modules are graphically placed in this illustration is arbitrary and may be executed at any order simultaneously.

As an example, indicated in box 904: The numeric sub-module finds an NR equivalent to the input NR sequence that equals 24. In the database vocabulary, this NR is represented by the character string ‘bi’.

The cyclic sub-module finds a CNR equivalent in database vocabulary to the input NR sequence 24 and a CKP equivalent to the KP input sequence 31, which in the database is represented by the character string ‘bag’.

The phonetic sub-module finds the character string ‘Kg’ in the database vocabulary.

As an example, indicated in box 905, according to some embodiments of the invention, the advanced spelling corrector (ASC) 900 module operates an ATD algorithms for the purpose of sorting the resulting list of optional corrections, generated by the sub-modules, in ascending ATD value order and outputs the said list 906.

According to some embodiments of the invention, the method for spell checking and correcting may be assimilated in a reduced numeric keypad 110 device or in an external system.

According to some embodiments of the invention, the said method may enable spell checking and correcting in several languages, simultaneously; wherein input text is typed through one language application of keypad device 110 while the parser searches through at least one database vocabulary of a different language, as well as the language that the user currently uses. The said “multi-lingual” option of the parser may be extremely useful in cases where the user needs to type in one language (e.g. Hebrew) and insert technical words in another (e.g. English). Using the said multi-lingual option saves the user from switching through languages options in the keypad device 110.

According to embodiments of the invention, one of the inventions implementation may be designated for SMS text messages used in terminals such as mobile phones, for example, where the keypad 110 is a mobile phone keypad 110. The processing unit 120 may enable spell checking and correcting to be carried out when the user input words in a text message using the mobile phone's keypad 110.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A method for spell checking of an input text inserted by a user through a multiple-typing reduced numeric keypad of a communication device, wherein the correction is based on comparison to at least one given reference database vocabulary said method comprising the steps of:
translating the input text to representation sequences Numeric Representation (NR) and Key Presses (KP), wherein said translation relates to the typing method and keypad design;
searching the reference database for NR sequences equivalent to said translated input text NR;
calculating the typing distance (TD) between the text corresponding with the equivalent NR sequences found in the database and the KP sequence of the input text;
sorting said text of equivalent NR sequences according to the TD values.

2. The method of claim 1 wherein said sorting of the text is carried out according to ascending TD values of the equivalents.

3. The method of claim 2 further comprises the steps of:
presenting of said sorted list to the user; and
allowing the user to select the desirable equivalent text from said list.

4. The method of claim 2 further comprises the step of automatically replacing the input text with the NR equivalent of the smallest TD value.

5. The method of claim 1 further comprises the step of integrating at least one module for checking and correcting of said input text.

6. The method of claim 5 further comprises the steps of:
calculating the cyclic equivalents of the input text NR and KP (CNR and CKP); and
searching the database for text with NR and KP sequences that are equivalent to the input text CNR and CKP;
adding the text of the equivalent sequences to said list.

7. The method of claim 6 further comprises the steps of:
searching the database for text that is phonetically corresponding to the input text; and
adding phonetic corresponding text to said list.

8. The method of claim 7 further comprises the step of sorting said list according to an ascending advanced typing distance (ATD), wherein said ATD is calculated according to predefined weight values,
wherein the typing distance between each character of the input text and the corresponding character of the character of the list-text is calculated according to a given weight value ascribed to said distance.

9. A system for spell checking of an input text inserted by a user wherein said system is a communication device enabling to communicate through at least one communication network, said system comprising:
a multiple-tapping reduced numeric keypad comprising reduced keys, wherein said keys represent a set of predefined characters;
at least one database that contains a dictionary of words and their associated numeric representation (NR) and Key Presses (KP) sequences;
a processing unit enabling to retrieve data from the database and perform parsing of the input data, wherein said processing unit enables carrying out the spelling check and correction of the input text by translating said input text into NR and KP sequences and searching through the database to find equivalent NR and KP sequences.

10. The system of claim 9 wherein said processing unit enables producing and sorting of a list of optional corrected words by using the input text's KP sequence to calculate the typing distance (TD) of each word in the database that has the equivalent NR sequence to the input text NR,
wherein said sorting is carried out according to a descending value of the TD.

11. The system of claim 9 further comprising a number of spell-checking modules wherein at least one of said modules includes a method that enables producing a list of said corrected words according to ascending TD values,
wherein each module enables producing a list of resulting corrected words according to the module's spell-checking method,
wherein said list is sorted according to an advanced spelling corrector (ASC) algorithm that enables calculating an advanced TD (ATD) from the input text according to predefined weights of TD defined between the input characters and the characters of each corrected word produced by each module.

12. The system of claim 11 further enables updating the ATD weight values according to statistical learning processes enabled by the processing unit.

13. The system of claim 11 wherein at least one of said modules enables calculating the cyclic equivalents of the input text NR and KP (CNR and CKP); and searching the database for text with NR and KP sequences that are equivalent to the input text CNR and CKP.

14. The system of claim 13 wherein at least one of said modules enables searching the database for text that is phonetically corresponding to the input text and adding phonetically corrected words to said list.

15. The system of claim 9 wherein said keypad is a mobile phone's keypad.
wherein said processing unit enables spell checking and correcting to be carried out when the user input short messaging service (SMS) text messages and said transmission unit is the transmitter of said phone.
